(19) United States
(12) Patent Application Publication
(10) Pub. No.: US 2026/0158920 A1
(43) Pub. Date: Jun. 11, 2026

(54) POWER SUPPLY SYSTEM OF REFRIGERATOR FOR ELECTRIC VEHICLE AND METHOD OF OPERATING REFRIGERATOR

(71) Applicants: HYUNDAI MOTOR COMPANY, SEOUL (KR); KIA CORPORATION, SEOUL (KR)

(72) Inventors: Byoungcheol Jeong, Hwaseong-si (KR); Seungmin Kim, Hwaseong-si (KR)

(73) Assignees: HYUNDAI MOTOR COMPANY, SEOUL (KR); KIA CORPORATION, SEOUL (KR)

(21) Appl. No.: 19/339,241

(22) Filed: Sep. 24, 2025

(30) Foreign Application Priority Data
Dec. 10, 2024 (KR) 10-2024-0182331

(51) Int. Cl. B60L 1/00; B60K 35/10; B60K 35/28; B60L 3/00; B60L 50/60; B60L 53/10; B60N 3/10; F25D 11/00

(52) U.S. Cl. CPC B60L 1/003; B60K 35/10; B60K 35/28; B60L 3/0007; B60L 50/60; B60L 53/11; B60N 3/104; F25D 11/003; B60K 2360/178; B60L 2210/12; B60L 2250/16; F25D 2600/06; F25D 2700/12

(57) ABSTRACT

A power supply system of a refrigerator for an electric vehicle according to an example embodiment of the present disclosure includes a high-voltage battery that supplies electricity for refrigeration and power to a vehicle, an infotainment (IVI, In-Vehicle Infotainment) system that receives refrigeration information of the vehicle by being operated by a user, a communication controller that receives the refrigeration information input through the infotainment system, a battery management system that receives electricity from the high-voltage battery, and converts the electricity into electricity used for each component of the vehicle and distributes the electricity, and a refrigeration system that receives the refrigeration information from the communication controller and performs refrigeration.

### CROSS-REFERENCE TO RELATED APPLICATION(S)

This application claims priority to and the benefit of Korean Patent Application No. 10-2024-0182331 filed with the Korean Intellectual Property Office on Dec. 10, 2024, the entire contents of which are incorporated herein by reference.

### TECHNICAL FIELD

The present disclosure relates to a power supply system of a refrigerator for an electric vehicle and a method of operating the refrigerator, and more particularly, to a system for supplying power to a refrigerator using a mounted battery in an electric vehicle, without mounting a separate additional battery, and a method of operating the refrigerator.

### BACKGROUND

Specially-equipped containers such as refrigerator containers or freezer containers are for transporting goods such as various frozen or low-temperature foods. Refrigerators may be in the vehicle's cargo boxes to keep the temperature inside the cargo boxes at a low temperature.

A refrigerator may be configured to include a compressor that compresses a refrigerant at high temperature and high pressure, a condenser that condenses the compressed refrigerant, an expansion valve that expands the refrigerant that has passed through the condenser, and an evaporator in which the refrigerant that has passed through the expansion valve evaporates by exchanging heat with air at room temperature and taking the surrounding latent heat.

In recent years, research and development of electric vehicles that use electricity to run as eco-friendly means of transportation has increased, and electric vehicles also equipped with refrigerators as specially-equipped containers have been considered.

In order to supply power to a specially-equipped container of such electric vehicles, a separate battery pack for supplying power to the refrigerator is mounted in addition to an existing mounted high-voltage battery. This decreases fuel efficiency due to an increase in weight and increases investment costs, as a new separate battery package is configured in the vehicle.

### SUMMARY

The present disclosure provides a power supply system of a refrigerator of an electric vehicle for a specially-equipped container equipped with a high-voltage battery and a method of operating the refrigerator, without affecting the mileage, by supplying power for the refrigerator using thebattery mounted in the electric vehicle for the specially-equipped container, without mounting a separate additional battery.

A power supply system of a refrigerator for an electric vehicle according to an example embodiment of the present disclosure includes a high-voltage battery that supplies electricity for refrigeration and power to a vehicle, an infotainment (IVI, In-Vehicle Infotainment) system that receives refrigeration information of the vehicle by being operated by a user, a communication controller that receives the refrigeration information input through the infotainment system, a battery management system that receives electricity from the high-voltage battery, and converts the electricity into electricity (e.g., required) for each component of the vehicle and distributes the electricity, and a refrigeration system that receives the refrigeration information from the communication controller and performs refrigeration.

The refrigeration system may include a refrigerator controller that receives the refrigeration information from the communication controller and generates a refrigeration setting value, a refrigerator that receives the refrigeration setting value from the refrigerator controller and performs refrigeration, an outdoor unit that is connected to the refrigerator and receives air from the outside, and an indoor unit that is connected to the refrigerator and outputs the heat-exchanged air from the refrigerator into the vehicle.

The refrigerator controller may use 12 V of electricity obtained by converting the electricity of the high-voltage battery by a low DC-DC converter (LDC) and then distributed by the battery management system.

The refrigerator may use electricity supplied directly from the high-voltage battery.

The refrigerator controller may perform control such that supply of electricity from the high-voltage battery to the refrigerator is shut off in the event of a collision of the vehicle.

The refrigerator controller may perform control such that the operation of the refrigerator is terminated, when the state of charge (SOC) of the high-voltage battery is less than a first reference value.

When the state of charge of the high-voltage battery is equal to or more than a first reference value and less than a second reference value, the refrigerator controller may give a warning about the state of charge of the battery to the user, and perform control such that charging of the high-voltage battery is performed while the operation of the refrigerator is kept.

The first reference value may be (e.g., about) 10%, and the second reference value may be (e.g., about) 20%.

The high voltage battery may be charged through a fast charger, and the refrigeration information input to the infotainment system may be input to the refrigeration system and the battery management system, and the electricity of the high-voltage battery may be converted by the battery management system and supplied to the refrigeration system.

During charging of the high-voltage battery, by an electric-vehicle charging management system (VCMS), whether to shut off supply of electricity to the refrigeration system may be controlled by determining whether voltage input from the fast charger is appropriate.

Meanwhile, a method of operating a refrigerator for an electric vehicle according to an example embodiment of the present disclosure includes a step of starting a vehicle, a step of allowing a user to input refrigeration information through an infotainment system, a step of receiving the refrigeration information, input to the infotainment system, by a communication controller, a step of transmitting the refrigeration information from the communication controller to a refrigerator controller, a step of operating a refrigerator, when it is determined that a refrigerator operation target temperature has been reached, by the refrigerator controller, a step of determining whether an operation termination condition for the refrigerator has been satisfied, by the refrigerator controller, and a step of terminating the operation of the refrigerator, when it is determined that the operation termination condition for the refrigerator has been satisfied, by the refrigerator controller.

The refrigeration information may be a refrigeration setting temperature, a time, and a refrigeration target inside the vehicle.

The method of operating the refrigerator for the electric vehicle according to the example embodiment of the present disclosure may further include a step of determining whether the refrigerator is within operation allowance temperature and setting time ranges, by the refrigerator controller, and a step of transmitting the determination result to the user through the infotainment system, by the refrigerator controller, before the step of operating the refrigerator by the refrigerator controller.

The method of operating the refrigerator for the electric vehicle according to the example embodiment of the present disclosure may further include a step of giving a warning to the user through the infotainment system, by the refrigerator controller, when the refrigerator is out of the operation allowance temperature range or out of the setting time range, after the step of determining whether the refrigerator is within the operation allowance temperature and setting time ranges, by the refrigerator controller.

The operation termination condition for the refrigerator may be a condition in which the refrigeration setting time input to the infotainment system should elapse, or the user should turn off the power of the vehicle, or the state of charge of the high-voltage battery should be less than 10%.

The method of operating the refrigerator for the electric vehicle according to the example embodiment of the present disclosure may further include a step of displaying the state of charge of the high-voltage battery and giving a warning to the user through the infotainment system, when the state of charge of the high-voltage battery is equal to or more than 10% and less than 20%, and keeping the operation of the refrigerator while performing charging of the high-voltage battery, after the step of determining whether the operation termination condition for the refrigerator has been satisfied, by the refrigerator controller.

According to an example embodiment of the present disclosure, in an electric vehicle for a specially-equipped container equipped with a high-voltage battery, power for a refrigerator is supplied using the high-voltage battery mounted in the vehicle, without mounting a separate additional battery, whereby removing the difficulty in which a new additional battery is designed.

Further, the present disclosure does not negatively impact fuel efficiency due to an increase in weight, and the does not increase the investment, development, and material costs as compared to a separately mounted battery.

Furthermore, while providing a specially-equipped container for an electric vehicle, the refrigerator used in an existing refrigerator/freezer container may be made removable and replaceable, so that in the event of a refrigerator failure in the future, the refrigerator alone can be replaced without replacing the refrigerator/freezer container.

### BRIEF DESCRIPTION OF THE DRAWINGS

FIG. 1 is a view schematically illustrating a state where a power supply system of a refrigerator for an electric vehicle according to an example embodiment of the present disclosure is provided in a vehicle.

FIG. 2 is a view schematically illustrating a refrigeration system of the power supply system of the refrigerator for the electric vehicle according to the example embodiment of the present disclosure.

FIG. 3 is a view schematically illustrating a communication path for operating the refrigerator using a high-voltage battery in the refrigeration system of the power supply system of the refrigerator for the electric vehicle according to the example embodiment of the present disclosure.

FIG. 4 is a view schematically illustrating the operation process of the refrigeration system of the power supply system of the refrigerator for the electric vehicle according to the example embodiment of the present disclosure.

FIG. 5 is a flow chart illustrating a method of operating the refrigerator for the electric vehicle according to the example embodiment of the present disclosure.

### DETAILED DESCRIPTION

In the following detailed description, certain example embodiments of the present disclosure are shown and described, simply by way of illustration. The present disclosure can be variously implemented and may not be limited to the following example embodiments.

Further, in various example embodiments, the components having the same configuration are designated by the same reference numerals, and among them, the component in one example embodiment will be representatively described, and in the other example embodiments, only components from those of the example embodiment will be described.

The drawings are schematic and may not be illustrated in accordance with a scale. Relative dimensions and ratios of portions in the drawings are illustrated to be exaggerated or reduced in size for clarity and convenience, and the dimensions are just examples and are not limiting. In addition, for the same structures, elements, or components illustrated in two or more drawings, the same reference numerals may be used to show similar features. When an element is referred to as being “on” another element, it can be directly on the other element or intervening elements may also be present.

The drawings show an example embodiment of the present disclosure in detail. Therefore, various modifications of the drawings may be expected. Example embodiments may not be limited to specific shapes of the illustrated regions, and for example, includes modifications of the shapes by manufacturing.

Hereinafter, a power supply system of a refrigerator for an electric vehicle according to an example embodiment of the present disclosure will be described in detail with reference to the accompanying drawings.

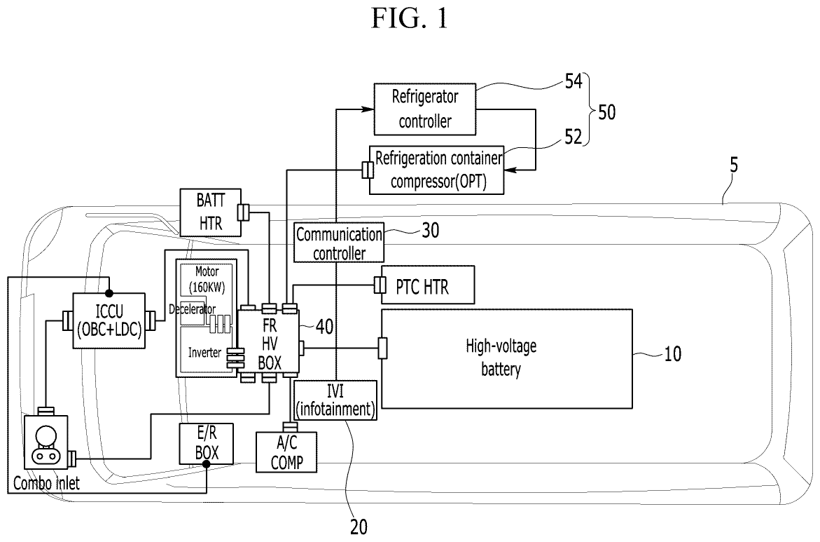

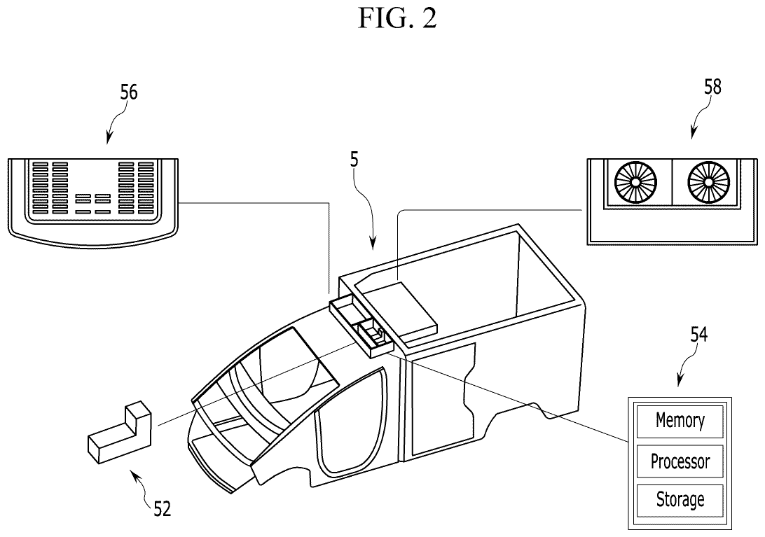

FIG. 1 is a (e.g., conceptual) view schematically illustrating a state where a power supply system of a refrigerator for an electric vehicle according to an example embodiment of the present disclosure is provided in a vehicle, and FIG. 2 is a view schematically illustrating a refrigeration system of the power supply system of the refrigerator for the electric vehicle according to the example embodiment of the present disclosure.

Referring to FIG. 1, a power supply system of a refrigerator for an electric vehicle according to an example embodiment of the present disclosure includes a high-voltage battery 10, an infotainment (IVI; In-Vehicle Infotainment) system 20, a communication controller 30, a battery management system (HV BOX; high voltage box) 40, and a refrigeration system 50.

The high-voltage battery 10 supplies electricity for refrigeration and power to a vehicle 5. The vehicle 5 may be an electric vehicle. The high-voltage battery 10 may be a lithium ion battery, and may have a voltage of about 800 V or more and a battery capacity of about 70 Kw or more.

The battery management system 40 receives electricity from the high-voltage battery 10, and converts the electricity into electricity used (e.g., required) for each component of the vehicle 5 and distributes the electricity.

The battery management system 40 may be a high-voltage junction box, and may distribute high-voltage electricity to high-voltage parts such as a slow battery charger (on-board charger (OBC)), a low DC-DC converter (LDC), an inverter, a battery heater (BATT HTR), and an air conditioner compressor (A/C COMP). In other words, the battery management system 40 may be (e.g., serve as) an electricity distributor for supplying the high voltage of the high-voltage battery 10 to other parts.

The infotainment system 20 receives refrigeration information of the vehicle 5 by being operated by a user (driver). “Infotainment” may be an integrated multimedia system that combines “information” and “entertainment” which refers to various forms of entertainment. A traditional function such as a navigation system or an audio system is a device for checking various information provided by the vehicle and manipulating the function.

The communication controller 30 receives refrigeration information input through the infotainment system 20 by the user, and the refrigeration system 50 receives the refrigeration information from the communication controller 30 and performs refrigeration.

Referring to FIG. 2, the refrigeration system 50 includes a refrigerator controller 54 and a refrigerator (refrigeration compressor) 52.

The refrigerator controller 54 receives the refrigeration information from the communication controller 30, generates a refrigeration setting value, determines various conditions for the operation of the refrigerator 52, and controls the operation and operation termination of the refrigerator 52 on the basis of the determination result. The refrigerator controller 54 may be implemented as one or more processors that operate according to a set program, and the set program may be programmed to perform each step of the method of operating the refrigerator for the electric vehicle according to an embodiment of the present invention. The refrigerator controller 54 may include a memory, a processor, and a storage. The storage may generate and store refrigeration setting values using refrigeration information received from the communication controller 30, and the processor determines (e.g., all) conditions for the operation of the refrigerator and transmits operation and operation termination commands of the refrigerator 52 to the refrigerator 52 from the memory based on the results.

The refrigerator controller 54 may use about 12 V of electricity obtained by converting the electricity of the high-voltage battery 10 by the low DC-DC converter (LDC) and then distributed by the battery management system 40. In this case, about 12 V may be on-vehicle load power.

The refrigerator controller 54 may control to shut off supply of electricity from the high-voltage battery 10 to the refrigerator 52 in the event of a collision of the vehicle 5.

Further, the refrigerator controller 54 may perform control such that the operation of the refrigerator 52 is terminated (e.g., stopped), when the state of charge (SOC) of the high-voltage battery 10 is less than a first reference value. Furthermore, the refrigerator controller 54 may give a warning about the state of charge of the battery to the user and perform control such that charging of the high-voltage battery 10 is performed while the operation of the refrigerator 52 is kept, when the state of charge of the high-voltage battery 10 is equal to or more than the first reference value and less than a second reference value. In this case, for example, the first reference value and the second reference value may be set to 10% and 20%, respectively.

The refrigerator 52 includes a refrigeration compressor, and receives the refrigeration setting value from the refrigerator controller 54 and performs refrigeration. Further, the refrigerator is operated or stopped in response to the various conditions determined by the refrigerator controller 54.

The refrigerator 52 may use electricity supplied (e.g., directly) from the high-voltage battery 10.

In the refrigerator 52, an outdoor unit 56 and an indoor unit 58 are connected. The outdoor unit 56 receives air from the outside and supplies it into the refrigerator 52, and the indoor unit 58 outputs the air, cooled to a low temperature by heat exchange inside the refrigerator, into the vehicle 5. To maintain a low temperature in the refrigerator 52, air from outside the vehicle is drawn in through the outdoor unit 56 of the refrigerator 52, interior air is made low temperature (below 0° C.) in the refrigerator 52, and then output into the vehicle through the indoor unit 58 of the refrigerator 52.

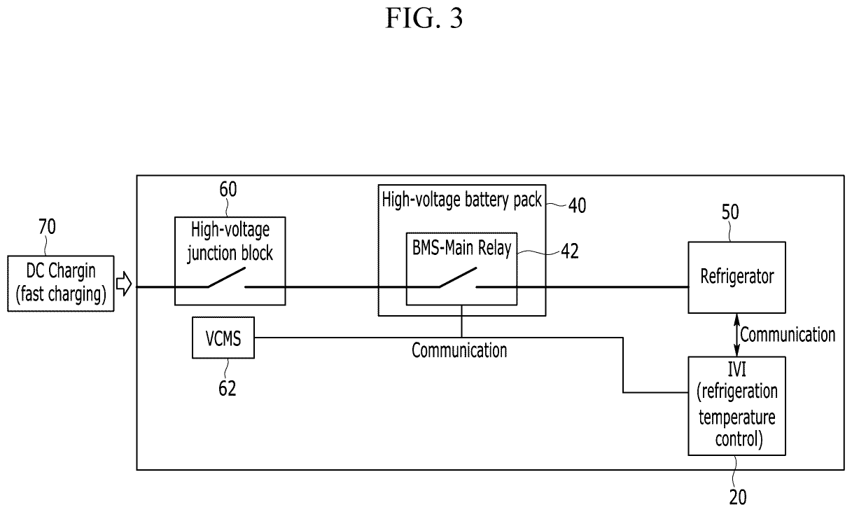

FIG. 3 is a view schematically illustrating a communication path for operating the refrigerator using a high-voltage battery in the refrigeration system of the power supply system of the refrigerator for the electric vehicle according to the example embodiment of the present disclosure.

Referring to FIG. 3, the high-voltage battery 10 is charged through a fast charger 70, and the refrigeration information input to the infotainment system 20 is input to the refrigeration system 50 and the battery management system 40.

The electricity of the high-voltage battery 10 may be converted by the battery management system 40 and supplied to the refrigeration system 50.

Meanwhile, referring to FIGS. 1 and 3 together, the refrigerator controller 54 of the refrigeration system 50 may perform control such that supply of electricity from the high-voltage battery 10 to the refrigerator 52 of the refrigeration system is shut off in the event of a collision of the vehicle. In other words, when a collision of the vehicle occurs, the refrigerator controller 54 may operate a relay switch 42 of the battery management system 40 such that the relay switch is switched to (e.g., becomes) an off (circuit separation) state, thereby shutting off supply of the high-voltage current of the high-voltage battery 10, connected to the relay switch 42, to the refrigerator 52.

Meanwhile, charging of the high-voltage battery 10 by the fast charger 70 may be kept or interrupted by the on/off operation of a switch of a high-voltage junction block 60. As shown in FIG. 3, when the switch (relay) inside the high-voltage junction block 60 is ON, the voltage/current of the fast charger 70 is in a state of charging the high-voltage battery 10, and when the switch (relay) inside the high-voltage junction block 60 is OFF, the voltage/current of the fast charger 70 is in a state where it cannot charge the high-voltage battery 10.

The infotainment system 20 may receive temperature information input by the user, and may perform communication with the refrigeration system 50 and the battery management system 40. Further, the infotainment system 20 may perform communication with an electric-vehicle charging management system (VCMS) 62. The electric-vehicle charging management system 62 may control whether to shut off supply of electricity to the refrigeration system 50 by determining whether the voltage input from the fast charger 70 is appropriate during charging of the high-voltage battery 10.

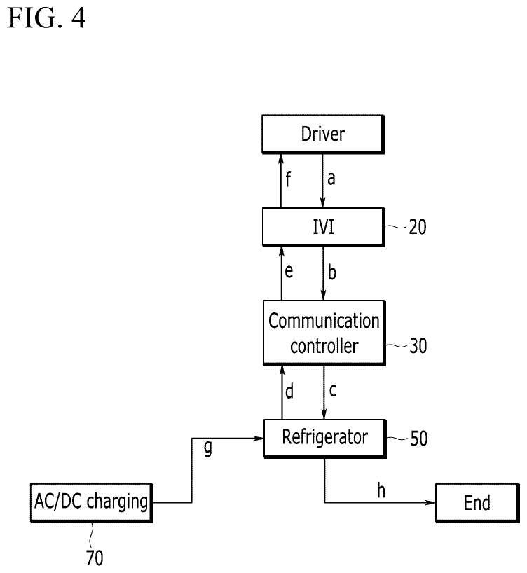

FIG. 4 is a view schematically illustrating the operation process of the refrigeration system of the power supply system of the refrigerator for the electric vehicle according to the example embodiment of the present disclosure.

Referring to FIG. 4, first, in a state where the vehicle has been started, the user (driver) inputs the refrigeration information through the infotainment system 20 (see the reference symbol “a”). The refrigeration information may be a refrigeration setting temperature, a time, and/or a refrigeration target inside the vehicle 5. The refrigeration target may be, for example, for fish (a setting temperature of −10° C.), fresh food (a setting temperature of +2° C.), etc.

The refrigeration information input to the infotainment system 20 is transmitted to the communication controller 30 (see the reference symbol “b”). Subsequently, the communication controller 30 transmits the refrigeration information to the refrigeration system 50 (see the reference symbol “c”).

The refrigerator controller 54 of the refrigeration system 50 receives the refrigeration information, generates a refrigeration setting value, and transmits the refrigeration setting value to the refrigerator 52. Further, the refrigerator controller 54 operates the refrigerator 52 when it is determined that an operation target temperature which is a refrigeration setting value has been reached.

Furthermore, the refrigerator 52 may include a refrigerator temperature sensor, and the refrigerator temperature sensor may (e.g., continuously) monitors the temperature for the setting time. The temperature sensed by the refrigerator 52 is transmitted to the communication controller 30 (see the reference symbol “d”), and the communication controller 30 displays the temperature on the infotainment system 20 (see the reference symbol “e”). If the operation target temperature is reached within the setting time, the infotainment system 20 notifies the target temperature arrival information to the user by a pop-up alarm or a sound (see the reference symbol “f”).

Meanwhile, the refrigerator controller 54 determines whether an operation termination condition for the refrigerator 52 has been satisfied, and terminates the operation of the refrigerator 52 when it is determined that the operation termination condition has been satisfied (see the reference symbol “h”). The operation termination condition for the refrigerator 52 may be set as a condition in which the refrigeration setting time input to the infotainment system 20 should elapse, or the user should turn off the power of the vehicle 5, or the state of charge (SOC) of the high-voltage battery 10 should be less than about 10%.

Meanwhile, when the state of charge of the high-voltage battery 10 is equal to or more than about 10% and less than about 20%, the high-voltage battery 10 may be charged, and during the charging of the high-voltage battery 10, the operation of the refrigerator 52 may be performed using electricity supplied by the fast charger 70, not by the electricity of the high-voltage battery 10 (see the reference symbol “g”).

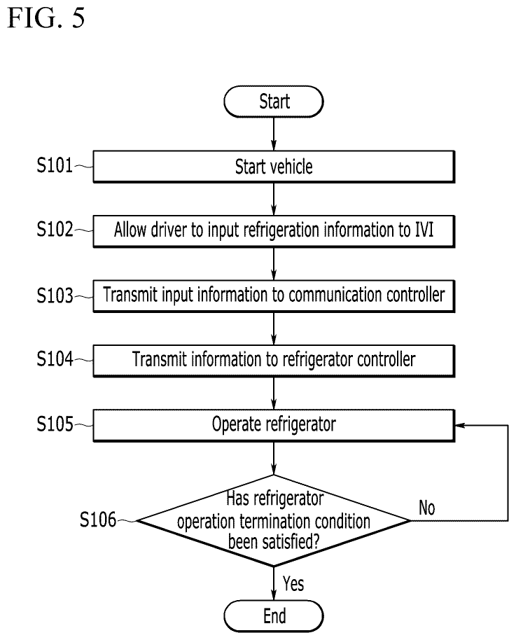

FIG. 5 is a flow chart illustrating a method of operating the refrigerator for the electric vehicle according to the example embodiment of the present disclosure.

Referring to FIG. 5, first, the vehicle is started (S101), and the user inputs the refrigeration information through the infotainment system 20 (S102). The refrigeration information may be a refrigeration setting temperature, a time, and/or a refrigeration target inside the vehicle 5.

Thereafter, by the communication controller 30, the refrigeration information input to the infotainment system 20 is received (S103), and the refrigeration information is transmitted to the refrigerator controller 54 (S104).

The refrigerator controller 54 receives the refrigeration information, generates the refrigeration setting value, determines whether the operation target temperature for the refrigerator 52 has been reached, and operates the refrigerator 52 when it is determined that the operation target temperature according to the refrigeration setting value has been reached (S105).

The refrigerator controller 54 may determine whether the refrigerator 52 is within an operation allowance temperature and setting time ranges, and inform the determination result to the user through the infotainment system 20.

Further, when the refrigerator 52 is out of the operation allowance temperature range or out of the setting time range, the refrigerator controller 54 may give a warning to the user through the infotainment system 20.

While the refrigerator 52 is operating, the refrigerator controller 54 determines whether the operation termination condition for the refrigerator 52 has been satisfied (S106).

The operation termination condition for the refrigerator 52 may be set as a condition in which the refrigeration setting time input to the infotainment system 20 should elapse, or the user should turn off the power of the vehicle, or the state of charge (SOC) of the high-voltage battery 10 should be less than 10%.

By the refrigerator controller 54, the operation of the refrigerator 52 is stopped (e.g., terminated) when it is determined that the operation termination condition for the refrigerator 52 has been satisfied.

Meanwhile, before whether the operation termination condition for the refrigerator 52 has been satisfied is determined (S106), by the refrigerator controller 54, when it is determined that the state of charge of the high-voltage battery 10 is equal to or more than 10% and less than 20%, the state of charge of the high-voltage battery 10 is displayed and a warning is given to the user through the infotainment system 20, and the operation of the refrigerator 52 may continue (e.g., be kept) while charging of the high-voltage battery 10 is performed.

According to an example embodiment of the present disclosure, in an electric vehicle for a specially-equipped container equipped with a high-voltage battery, power for a refrigerator is supplied using the high-voltage battery mounted in the vehicle, without mounting a separate additional battery, whereby designing a configuration for a a new additional battery is avoided.

Further, the present disclosure avoids decreasing fuel efficiency due to an increase in weight of having an additional battery, and the present disclosure avoids additional investment, development, and material costs, as compared to a system with a separate additional battery mounted therein.

Furthermore, a refrigerator of an existing refrigerator/freezer container may be removable and replaced in the event of a refrigerator failure in the future, the refrigerator alone can be replaced without replacing the refrigerator/freezer container.

While this disclosure has been described in connection with what is presently considered in the example embodiments, the disclosure is not limited to the disclosed embodiments. On the contrary, the present disclosure is intended to cover various modifications and (e.g., substantially) equivalent arrangements included within the spirit and scope of the present disclosure and the appended claims.

What is claimed is:

1. A power supply system of a refrigerator for an electric vehicle comprising:
a high-voltage battery that supplies electricity for refrigeration and power to a vehicle;
an infotainment system operated by a user, the infotainment system is configured to receive refrigeration information of the vehicle;
a communication controller configured to receive the refrigeration information input from the infotainment system;
a battery management system configured to receive electricity from the high-voltage battery, and converts the electricity into electricity for each component of the vehicle and distributes the electricity; and
a refrigeration system configured to receive the refrigeration information from the communication controller and performs refrigeration.

2. The power supply system of the refrigerator for the electric vehicle according to claim 1, wherein
the refrigeration system includes:
a refrigerator controller configured to receive the refrigeration information from the communication controller and generates a refrigeration setting value; and
a refrigerator configured to receive the refrigeration setting value from the refrigerator controller and performs refrigeration.

3. The power supply system of the refrigerator for the electric vehicle according to claim 2, wherein:
the refrigeration system further includes:
an outdoor unit coupled to the refrigerator, the outdoor unit receives air from outside; and
an indoor unit coupled to the refrigerator and outputs heat-exchanged air from the refrigerator into the vehicle.

4. The power supply system of the refrigerator for the electric vehicle according to claim 2, wherein:
the refrigerator controller is configured to use 12 V of electricity by converting the electricity of the high-voltage battery via a low DC-DC converter (LDC) and distributing the electricity to the battery management system.

5. The power supply system of the refrigerator for the electric vehicle according to claim 4, wherein:
the refrigerator uses electricity directly from the high-voltage battery.

6. The power supply system of the refrigerator for the electric vehicle according to claim 5, wherein:
the refrigerator controller shuts off supply of electricity from the high-voltage battery to the refrigerator in the event of a collision of the vehicle.

7. The power supply system of the refrigerator for the electric vehicle according to claim 5, wherein:
the refrigerator controller terminates operation of the refrigerator, when a state of charge (SOC) of the high-voltage battery is less than a first reference value.

8. The power supply system of the refrigerator for the electric vehicle according to claim 7, wherein:
when the state of charge of the high-voltage battery is equal to or more than the first reference value and less than a second reference value, the refrigerator controller provides a warning to the user about the state of charge of the battery.

9. The power supply system of the refrigerator for the electric vehicle according to claim 8, further comprising charging the high-voltage battery during operation of the refrigerator.

10. The power supply system of the refrigerator for the electric vehicle according to claim 8, wherein:
the first reference value is about 10%.

11. The power supply system of the refrigerator for the electric vehicle according to claim 8, the second reference value is about 20%.

12. The power supply system of the refrigerator for the electric vehicle according to claim 1, wherein:
the refrigeration information input to the infotainment system is input to the refrigeration system and the battery management system; and
the electricity of the high-voltage battery is converted by the battery management system and supplied to the refrigeration system.

13. The power supply system of the refrigerator for the electric vehicle according to claim 1, wherein the high-voltage battery is charged through a fast charger.

14. The power supply system of the refrigerator for the electric vehicle according to claim 13, wherein:
during charging of the high-voltage battery,
by an electric-vehicle charging management system (VCMS), shutting off the supply of electricity to the refrigeration system is controlled by voltage input from the fast charger.

15. A method of operating a refrigerator for an electric vehicle comprising:
starting a vehicle;
inputting refrigeration information into an infotainment system by a user;
receiving the refrigeration information, input to the infotainment system, by a communication controller;
transmitting the refrigeration information from the communication controller to a refrigerator controller;
operating a refrigerator, when the refrigerator controller determines that a refrigerator operation target temperature has been reached;
determining, by the refrigerator controller, whether an operation termination condition for the refrigerator has been satisfied; and
terminating the operation of the refrigerator, when the refrigerator controller determines the operation termination condition for the refrigerator has been satisfied.

16. The method of operating the refrigerator for the electric vehicle according to claim 15, wherein:
the refrigeration information is a refrigeration setting temperature, a time, and a refrigeration target inside the vehicle.

17. The method of operating the refrigerator for the electric vehicle according to claim 15, further comprising:
before operating the refrigerator by the refrigerator controller,
determining a result, by the refrigerator controller, whether the refrigerator is within operation allowance temperature range and setting time range; and
transmitting, by the refrigerator controller, the determination to the user through the infotainment system.

18. The method of operating the refrigerator for the electric vehicle according to claim 17, further comprising:
after determining, by the refrigerator controller, whether the refrigerator is within the operation allowance temperature range and setting time range,
warning the user through the infotainment system, by the refrigerator controller, when the refrigerator is outside the operation allowance temperature range or outside the setting time range.

19. The method of operating the refrigerator for the electric vehicle according to claim 15, wherein:
the operation termination condition for the refrigerator is a condition in which the setting time input to the infotainment system should elapse, or
the user should turn off power of the vehicle, or
a state of charge of a high-voltage battery should be less than 10%.

20. The method of operating the refrigerator for the electric vehicle according to claim 19, further comprising:
after determining, by the refrigerator controller, whether the operation termination condition for the refrigerator has been satisfied,
displaying the state of charge of the high-voltage battery and warning the user through the infotainment system, when the state of charge of the high-voltage battery is equal to or more than 10% and less than 20%, and operating the refrigerator while charging the high-voltage battery.
